(19) United States
(12) Patent Application Publication
(10) Pub. No.: US 2006/0161415 A1
(43) Pub. Date: Jul. 20, 2006

(54) Driver handler object framework

(75) Inventors: Miles Katsumi Takahashi, Seattle, WA (US); Zhijun Yang, Sammamish, WA (US)

Correspondence Address: WOLF GREENFIELD (Microsoft Corporation);C/O WOLF, GREENFIELD & SACKS, P.C., FEDERAL RESERVE PLAZA, 600 ATLANTIC AVENUE, BOSTON, MA, 02210-2206, US

(73) Assignee: Microsoft Corporation, Redmond, WA (US)

(21) Appl. No.: 11/038,317

(22) Filed: Jan. 18, 2005

(51) Int. Cl. G06F 13/10

(52) U.S. Cl. 703/21

(57) ABSTRACT

Disclosed is a framework that provides a method for testing device driver installation tasks which would otherwise have to be done manually using actual hardware. By providing the capability to dynamically create the appearance of many types of hardware devices installed on the system the need to have test machines with the actual hardware is eliminated. In one embodiment a driver handler object framework is implemented which can be used to simulate the presence of hardware devices and drivers. By using these drivers and test packages (or actual driver packages), testing can be accomplished without the large investment or requirement of additional hardware and software. The driver handler object framework also provides a set of methods, objects, and xml schema definitions that can be used with the pseudo device drivers to setup, install, verify, and clean-up the test systems in preparation and support of driver installations and updates.

### TECHNICAL FIELD

The present invention pertains to computer systems and computer system devices and, more particularly, to delivery, configuration, and testing of driver installations.

### BACKGROUND OF THE INVENTION

Conducting thorough testing of new hardware and software components is an essential step in developing and releasing products to market. To ensure that a particular component is compatible across as large of a user base as possible it needs to be tested with a wide variety of system configurations. However, maintaining such a large on-hand cache of various hardware and software components can prove to be a technically, financially, and administratively burdensome task. By reducing the number of actual hardware and software components to be maintained many advantages are realized, such as lower total lifecycle infrastructure costs and fewer required software licenses. Moreover, many environmental benefits can also be achieved, including hardware footprint reduction, power reduction, and reduced ambient cooling demands.

In the 1970's the concept of virtual machines was introduced in the VAX VMS environment. A virtual machine appears to be its own operating system running its own applications, but the virtual machine does not actually communicate with the hardware directly. Instead the virtual machine communicates to virtualized hardware and it is an underlying host operating system that actually handles the communication directly to the hardware. While virtual machine technology can be useful in testing software and hardware components and simulating an actual computer environment, virtual machine technology possesses some limitations which can hinder its use in software and hardware component testing. For example, the virtual machine will typically be constrained by the physical machine and hardware that the virtual machine is spooled up on. This can be particularly problematic, for instance, when testing device driver installations and updates which typically call for many different configurations of installed hardware.

Accordingly, a need exists for a method or program that is able to handle the testing of driver installation, configuration, updating, and clean-up across many different system hardware configurations. The invention provides such a method. These and other advantages of the invention, as well as additional inventive features, will be apparent from the description of the invention provided herein.

### SUMMARY OF THE INVENTION

In view of the foregoing, the present invention provides a framework for testing device driver installation tasks which would otherwise have to be done manually using actual hardware by providing the capability to dynamically create the appearance of many types of hardware devices installed on the system, thus eliminating the need to have test machines with the actual hardware. In one embodiment a driver handler object framework is implemented which can be used to simulate the presence of hardware devices and drivers. By using these drivers and test packages (or actual driver packages), testing can be accomplished without the large investment or requirement of additional hardware and software. The driver handler object framework also provides a set of methods, objects, and xml schema definitions that can be used with the pseudo device drivers to setup, install, verify, and clean-up the test systems in preparation and support of driver installations and updates.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a schematic diagram of an exemplary computer architecture on which the driver handler object framework of the present invention can be implemented;

FIG. 2 is a schematic diagram showing the method for providing a driver handler object framework for testing device driver installation tasks of the present invention; and

FIG. 3 is a flowchart illustrating the method for providing a driver handler object framework for testing device driver installation tasks of the present invention.

### DETAILED DESCRIPTION OF THE INVENTION

In the description that follows, the invention is described with reference to acts and symbolic representations of operations that are performed by one or more computing devices, unless indicated otherwise. As such, it will be understood that such acts and operations, which are at times referred to as being computer-executed, include the manipulation by the processing unit of the computing device of electrical signals representing data in a structured form. This manipulation transforms the data or maintains them at locations in the memory system of the computing device, which reconfigures or otherwise alters the operation of the computing device in a manner well understood by those skilled in the art. The data structures where data are maintained are physical locations of the memory that have particular properties defined by the format of the data. However, while the invention is being described in the foregoing context, it is not meant to be limiting as those of skill in the art will appreciate that several of the acts and operations described hereinafter may also be implemented in hardware.

Turning to the drawings, wherein like reference numerals refer to like elements, the invention is illustrated as being implemented in a suitable computing environment. The following description is based on illustrated embodiments of the invention and should not be taken as limiting the invention with regard to alternative embodiments that are not explicitly described herein.

### I. Exemplary Environment

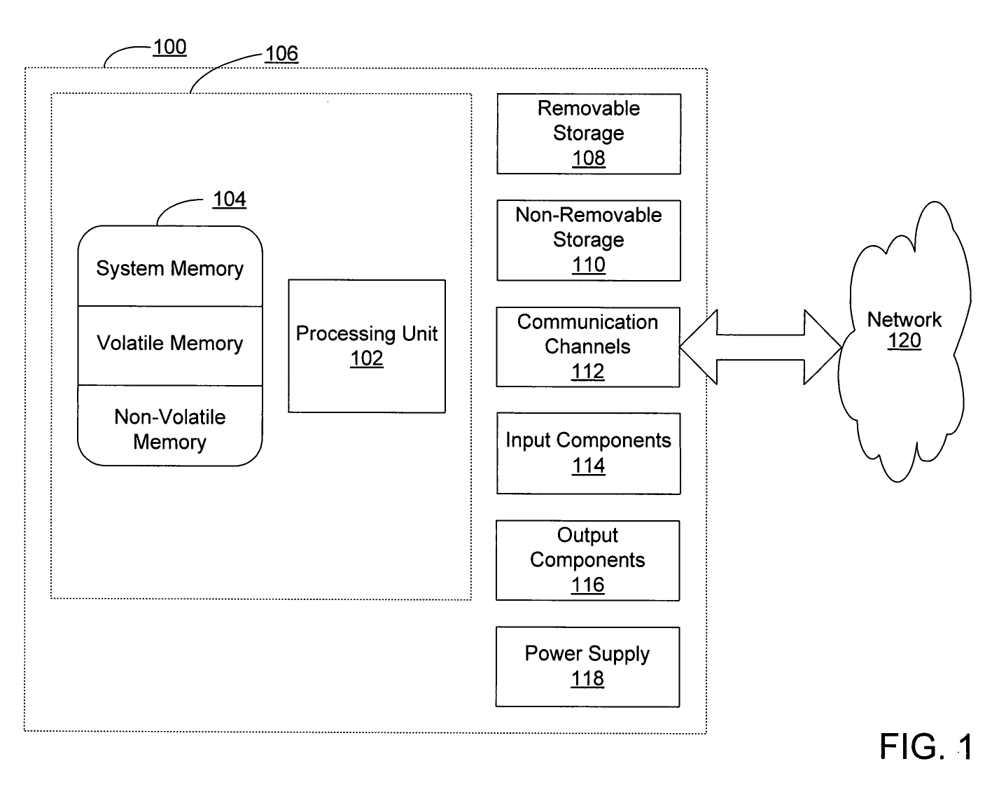

Referring to FIG. 1, in one embodiment the present invention relates to implementing a virtual storage device driver to dynamically create many types of storage devices, with different storage media, on a physical computer. The computer can be a device that may have one of many different computer architectures. For descriptive purposes, FIG. 1 shows a schematic diagram of an exemplary architecture usable for these devices. The architecture portrayed is only one example of a suitable environment and is not intended to suggest any limitation as to the scope of use or functionality of the invention. Neither should the computing devices be interpreted as having any dependency or requirement relating to any one or combination of components illustrated in FIG. 1. The invention is operational with numerous other general-purpose or special-purpose computing or communications environments or configurations. Examples of well known computing systems, environments, and configurations suitable for use with the invention include, but are not limited to, mobile telephones, pocket computers, personal computers, servers, multiprocessor systems, microprocessor-based systems, minicomputers, mainframe computers, and distributed computing environments that include any of the above systems or devices.

In its most basic configuration, a computing device 100 typically includes at least one processing unit 102 and memory 104. The memory 104 may be volatile (such as RAM), non-volatile (such as ROM and flash memory), or some combination of the two. This most basic configuration is illustrated in FIG. 1 by the dashed line 106.

Computing device 100 can also contain storage media devices 108 and 110 that may have additional features and functionality. For example, they may include additional storage (removable and non-removable) including, but not limited to, PCMCIA cards, magnetic and optical disks, and magnetic tape. Such additional storage is illustrated in FIG. 1 by removable storage 108 and non-removable storage 110. Computer-storage media include volatile and non-volatile, removable and non-removable media implemented in any method or technology for storage of information such as computer-readable instructions, data structures, program modules, or other data. Memory 104, removable storage 108, and non-removable storage 110 are all examples of computer-storage media. Computer-storage media include, but are not limited to, RAM, ROM, EEPROM, flash memory, other memory technology, CD-ROM, digital versatile disks, other optical storage, magnetic cassettes, magnetic tape, magnetic disk storage, other magnetic storage devices, and any other media that can be used to store the desired information and that can be accessed by the computing device.

Computing device 100 can also contain communication channels 112 that allow it to communicate with other devices. Communication channels 112 are examples of communications media. Communications media typically embody computer-readable instructions, data structures, program modules, or other data in a modulated data signal such as a carrier wave or other transport mechanism and include any information-delivery media. The term “modulated data signal” means a signal that has one or more of its characteristics set or changed in such a manner as to encode information in the signal. By way of example, and not limitation, communications media include wired media, such as wired networks and direct-wired connections, and wireless media such as acoustic, radio, infrared, and other wireless media. The term computer-readable media as used herein includes both storage media and communications media. The computing device 100 may also have input components 114 such as a keyboard, mouse, pen, a voice-input component, and a touch-input device. Output components 116 include screen displays, speakers, printers, and rendering modules (often called “adapters”) for driving them. The computing device 100 has a power supply 118. All these components are well known in the art and need not be discussed at length here.

### II. Driver Handler Object Framework

The present invention is directed to implementing a driver handler object framework for testing device driver installation tasks which would otherwise have to be done manually using actual hardware by providing the capability to dynamically create the appearance of many types of hardware devices installed on the system, thus eliminating the need to have test machines with the actual hardware. For illustrative purposes only, the driver handler object framework of the present invention is described as being implemented within the Microsoft Windows® operating system kernel, by Microsoft Corporation of Redmond, Wash. One of ordinary skill in the art will of course appreciate that the driver handler object framework of the present invention can be implemented in another operating system kernel using the published standards.

To allow driver developers to write device drivers that are source-code compatible across all Microsoft Windows® operating systems, the Windows Driver Model (WDM) was introduced. There are three kinds of WDM drivers: bus drivers, which drive an I/O bus and provide per-slot functionality that is device-independent; function drivers, which drive an individual device; and filter drivers, which filter I/O requests for a device, a class of devices, or a bus.

Each device typically has a bus driver for the parent I/O bus, a function driver for the device, and zero or more filter drivers for the device. A bus driver services a bus controller, adapter, or bridge; there is one bus driver for each type of bus on a machine. A function driver is the main driver for a device. A bus filter driver typically adds value to a bus and there can be any number of bus filter drivers for a bus. Lower-level filter drivers typically modify the behavior of device hardware. Upper-level filter drivers typically provide added-value features for a device.

A bus driver performs certain operations on behalf of the devices on its bus, including accessing device registers to physically change the power state of a device. For example, when the device goes to sleep, the bus driver sets device registers to put the device in the proper device power state. It should be noted, however, that a bus driver does not handle read and write requests for the devices on its bus. Read and write requests to a device are handled by the device's function driver. However, if the device is being used in raw mode the parent bus driver handles reads and writes for the device. A bus driver acts as the function driver for its controller, adapter, or bridge, and therefore manages device power policy for these components.

A function driver is the main driver for a device and is typically written by the device vendor. A function driver can service one or more devices. A function driver provides the operational interface for its device. Typically the function driver handles reads and writes to the device and manages device power policy. If a device is being driven in raw mode, it has no function driver and no upper or lower-level filter drivers. All raw-mode I/O is done by the bus driver and optional bus filter drivers.

Filter drivers are optional drivers that add value to or modify the behavior of a device. A filter driver can service one or more devices. Bus filter drivers typically add value to a bus and are optional. There can be any number of bus filter drivers for a bus. A bus filter driver could, for example, implement proprietary enhancements to standard bus hardware.

Lower-level filter drivers typically modify the behavior of device hardware and are optional. There can be any number of lower-level filter drivers for a device. A lower-level device filter driver monitors and/or modifies I/O requests to a particular device. Typically, such filters redefine hardware behavior to match expected specifications. A lower-level class filter driver monitors and/or modifies I/O requests for a class of devices. For example, a lower-level class filter driver for mouse devices could provide acceleration, performing a nonlinear conversion of mouse movement data.

Upper-level filter drivers typically provide added-value features for a device and are optional. There can be any number of upper-level filter drivers for a device. An upper-level device filter driver adds value for a particular device. For example, an upper-level device filter driver for a keyboard could enforce additional security checks. An upper-level class filter driver adds value for all devices of a particular class.

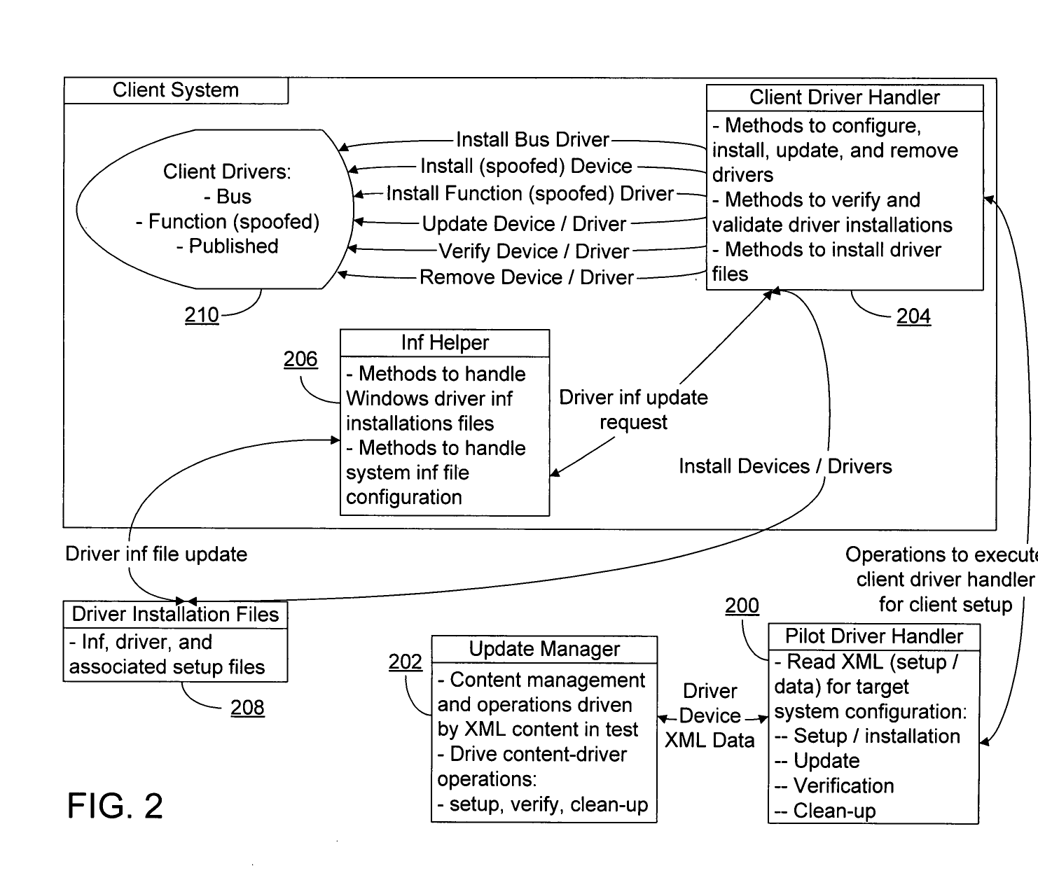

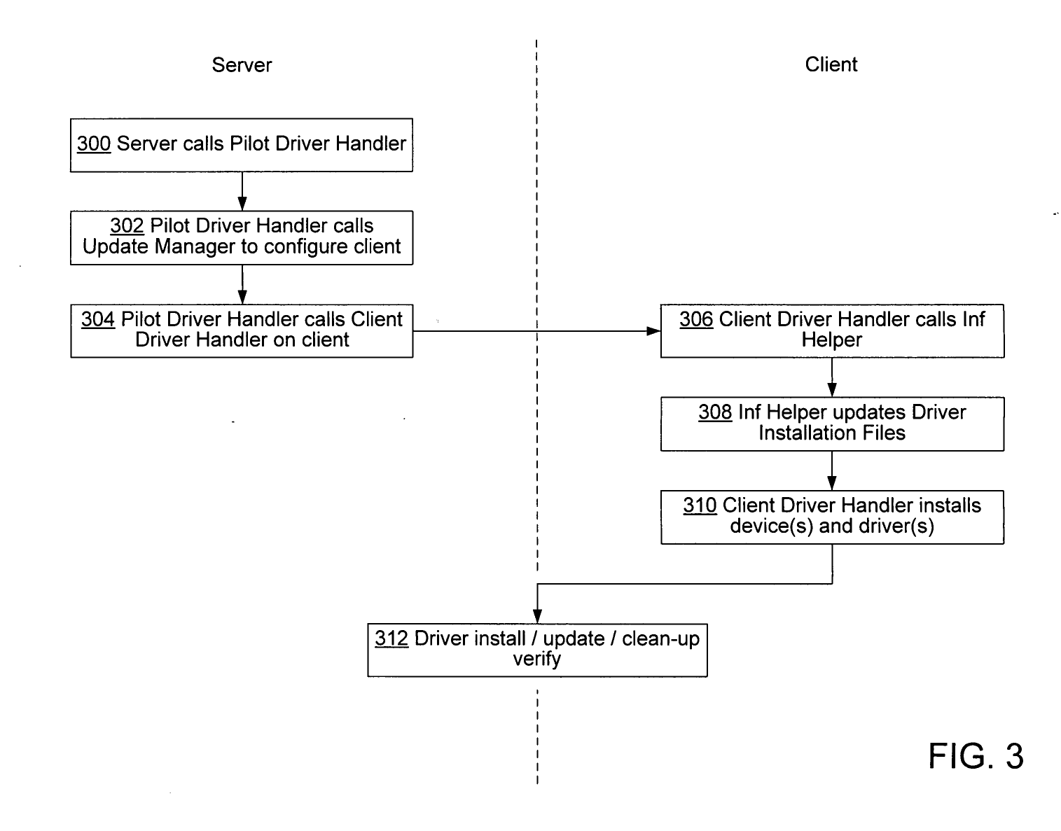

Referring now to FIGS. 2 and 3 the driver handler object framework of the present invention will now be described in further detail. At step 300, the server calls the pilot driver handler 200. Continuing at step 302, the pilot driver handler 200, calls the update manager 202. The update manager 202 serves as a content manager, providing an infrastructure that allows for publishing content. The pilot driver handler 200 reads in the hardware device configuration information from the update manager 202 as a specifically formatted XML (Extensible Markup Language) document that contains parameter and settings information such as model, manufacturer, driver, and hardware ID for the device.

Next, at step 304 the pilot driver handler 200 calls the client driver handler 204. The client driver handler 204 is a COM (Component Object Model) object that exposes functions for configuring, installing, updating, and uninstalling drivers on the client system 210. Continuing at step 306, the client driver handler 204 calls the inf helper 206. Next, at step 308 the inf helper 206 modifies the .inf file associated with the driver installation files 208. This modification will allow the device to be spoofed to mimic an actual hardware device on the client system 210, primarily through a spoofed hardware ID.

It should be noted that while the driver handler object framework of the present invention is being illustrated as implemented as a system distributed between a client and server, one of ordinary skill in the art will of course appreciate that it could also suitably be implemented on a single stand-alone system. For example, an application could reside on the client system that directly calls the client driver handler 204 and inf helper 206 components.

At step 310, the client driver handler 204 receives the updated inf file and associated driver installation files and at step 312 installs/updates the “devices” on the client system 210. Once the spoofed devices have been “installed” on the client system 210 any desired driver installation and/or installer methods, such as, for example Microsoft Windows® Update can be performed. Finally, at step 312 the client driver handler 204 can clean-up the client system 210 and verify that the installation was successful.

In view of the many possible embodiments to which the principles of this invention may be applied, it should be recognized that the embodiments described herein with respect to the drawing figures are meant to be illustrative only and should not be taken as limiting the scope of invention. For example, for performance reasons the method of the present invention may be implemented in hardware, rather than in software. Therefore, the invention as described herein contemplates all such embodiments as may come within the scope of the following claims and equivalents thereof.

What is claimed is:

1. A method for simulating an installed device on a computer system, the method comprising:
specifying a configuration for the installed device;
obtaining standard driver installation files corresponding to the configuration;
modifying at least one of the driver installation files, wherein the modifying comprises updating the at least one driver installation file to spoof a hardware ID; and
installing the modified driver installation files.

2. The method of claim 1 wherein the specifying a configuration for the installed device comprises defining an XML file.

3. The method of claim 1 wherein the at least one of the driver installation files is a .inf file.

4. The method of claim 1 further comprising verifying the installation of the modified driver installation files.

5. The method of claim 1 further comprising uninstalling the modified driver installation files.

6. The method of claim 5 further comprising verifying the uninstallation of the modified driver installation files.

7. The method of claim 1 further comprising updating the installation of the modified driver installation files.

8. A computer-readable medium having computer-executable instructions for performing a method for simulating an installed device on a computer system, the method comprising:
specifying a configuration for the installed device;
obtaining standard driver installation files corresponding to the configuration;
modifying at least one of the driver installation files, wherein the modifying comprises updating the at least one driver installation file to spoof a hardware ID; and
installing the modified driver installation files.

9. The computer-readable medium of claim 8 wherein the specifying a configuration for the installed device comprises computer-executable instructions for defining an XML file.

10. The computer-readable medium of claim 8 wherein the at least one of the driver installation files is a .inf file.

11. The computer-readable medium of claim 8 further comprising computer-executable instructions for verifying the installation of the modified driver installation files.

12. The computer-readable medium of claim 8 further comprising computer-executable instructions for uninstalling the modified driver installation files.

13. The computer-readable medium of claim 12 further comprising computer-executable instructions for verifying the uninstallation of the modified driver installation files.

14. The computer-readable medium of claim 8 further comprising computer-executable instructions for updating the installation of the modified driver installation files.

15. A system configured to simulate an installed device, comprising, a hardware management module, wherein the hardware management module:
specifies a configuration for the installed device;
obtains standard driver installation files corresponding to the configuration;
modifies at least one of the driver installation files, wherein the modification comprises updates to the at least one driver installation file to spoof a hardware ID; and
installs the modified driver installation files.

16. The system of claim 15 wherein the specification of a configuration for the installed device comprises an XML file.

17. The system of claim 15 wherein the at least one of the driver installation files is a .inf file.

18. The system of claim 15 wherein the hardware management module verifies the installation of the modified driver installation files.

19. The system of claim 15 wherein the hardware management module uninstalls the modified driver installation files.

20. The system of claim 15 wherein the hardware management module updates the installation of the modified driver installation files.
